(19) United States
(12) Patent Application Publication
(10) Pub. No.: US 2026/0264351 A1
(43) Pub. Date: Sep. 10, 2026

(54) METHOD FOR CONTROLLING COMPRESSOR DISPLAY FOR INFLATING AND REPAIRING TIRES AND RELATED COMPRESSOR

(71) Applicant: TEK GROUP SAGL, LUGANO (CH)

(72) Inventors: Maurizio MARINI, LUGANO (CH); Alessandro BUZZONI, LUGANO (CH)

(73) Assignee: TEK GROUP SAGL, LUGANO (CH)

(21) Appl. No.: 19/491,414

(22) PCT Filed: Jun. 10, 2024
(86) PCT No.: PCT/IB2024/055677

§ 371 Date: Dec. 9, 2025

(30) Foreign Application Priority Data
Jun. 9, 2023 (IT) 102023000011901

(51) Int. Cl. B29C 73/02; B29L 30/00; G08B 7/06; G08B 21/18

(52) U.S. Cl. CPC B29C 73/025; G08B 7/06; G08B 21/182; B29L 2030/00

(57) ABSTRACT

A handheld portable compressor for inflating tires of a motorized land vehicle comprising an electronic control unit programmed to provide visual and/or acoustic indications of the compressor's operating state, e.g., inflation or sealant liquid injection, based on a pressure sensor.

### TECHNICAL FIELD OF THE INVENTION

The present invention relates to a compressor for inflating and repairing inflatable objects and a related method for monitoring the operating status of the compressor. More specifically, the invention pertains to a compressor for inflating and repairing tires of motorized land vehicles, which includes a display.

### BACKGROUND ART

Devices for inflating and repairing tires of motorized land vehicles are known in the art and comprise an electrically operated compressor unit, a container for a sealing liquid that is injected into the tire when needed via a pressurized air flow from the compressor unit through a fluid line, and a display for showing pressure values. However, these devices are unreliable in displaying pressure values when used at extreme temperatures. Furthermore, when these devices operate in repair mode, i.e. when at the same time as the inflation action there is also an injection action of the sealing liquid, the display cannot show accurate pressure values until the pressure signal stabilizes.

### OBJECTIVES AND SUMMARY OF THE INVENTION

The objective of the present invention is to at least partially overcome the aforementioned disadvantages by providing a compressor for inflating and repairing tires that includes a display capable of functioning at extreme temperatures and also providing an indication of the device's operational status during use, including during the transient period associated with the injection phase of the sealing liquid.

The objective of the present invention is achieved by a portable hand-held compressor for inflating vehicle tires, comprising:
An outer casing;
A compressor unit, preferably with an electric motor, enclosed within the casing;
A display applied to the casing, comprising:
   At least one seven-segment LED configured to represent a number or a letter, with one LED for each segment;
   A layer positioned over the at least one seven-segment LED, having a non-obscured zone corresponding to the underlying LED segments and an obscured zone elsewhere so that when said segments are illuminated and emit light towards the protective material layer, the display is illuminated in the non-obscured areas to display at least one alphanumeric character on the screen;
A pressure sensor connected to an inflation line attached to an outlet of the compressor unit;
An LED control device designed to control the lighting of the LED segments based on the signal trend over time received from the pressure sensor.

In this way, it is possible to equip a portable compressor and vehicle accessory, such as for a car or van, with a luminous display that is perfectly readable even at night and at low temperatures (e. g., down to −40° C.) as required for the homologation of vehicle accessories.

According to a preferred embodiment, the compressor is provided in a kit also comprising a container of sealing liquid with an inlet for pressurized air and an outlet for the sealing liquid to be injected into a tire to be repaired. In this case, the compressor includes an additional light device, which may or may not coincide with the LED display, positioned on the casing, a timer, and an additional control device, integrated with or separated from the LED control device, programmed to configure the additional light device in a first light mode representing a first operational state of the kit; and in a second light mode representing a second operational state of the kit, the first and second light modes are defined based on a signal from the pressure sensor and the timer.

In this way, the user is informed about the operating mode of the compressor. For instance, during the repair of a tire, the pressure shows an irregular trend with high peaks when the sealing liquid is injected; after the sealing liquid has been injected, the pressure value progressively increases during the tire inflation until reaching values lower than the peaks measurable during the sealing liquid injection. Therefore, by monitoring the pressure levels over time during the operation of the kit when repairing a tire, it is possible to identify at least two operating states, i.e., the injection of the sealing liquid and the inflation after the sealing liquid has been injected. It is also possible to identify a malfunction condition when the compressor is active for a time limit exceeding an average injection and inflation time, which can be calculated, for example, based on the compressor's flow rate, preferably fixed.

In fact, on the one hand, the use of LEDs extends the possibility of receiving information on pressure values even in environments with extreme temperatures, and on the other hand, the light and/or sound signalling system informs the user about how the compressor is working even during the transitional period when the pressure is irregular and thus a reading cannot be generated to display.

Preferably, the compressor's display includes at least one circular LED segment to represent a decimal point. Preferably, the compressor's display includes a group of LEDs representing possible units of measurement of the pressure according to which the numerical value is expressed and a selection button configured to convert the measurement according to a plurality of reference systems.

Preferably, the compressor's display comprises a plurality of nine, fourteen, sixteen-segment LEDs to display all alphanumeric characters, generating complex text messages in addition to or as an alternative to acoustic and/or light signals.

Preferably, the compressor includes an acoustic device configured to acoustically signal to a user the first or second operating state during inflation and/or repair operations so that it is not necessary to look at the screen while the compressor is in use. Other advantages of the present invention are discussed in the description and cited in the dependent claims.

### BRIEF DESCRIPTION OF THE DRAWINGS

The invention is described below based on non-limiting examples illustrated by way of example in the following figures, which respectively refer to:

FIG. 1 shows a perspective view of a compressor for inflating motorized land vehicle tires according to the present invention;

FIG. 2 shows in detail the display according to the present invention;

FIG. 3 shows a flow chart relating to the method for controlling the operating status of the compressor;

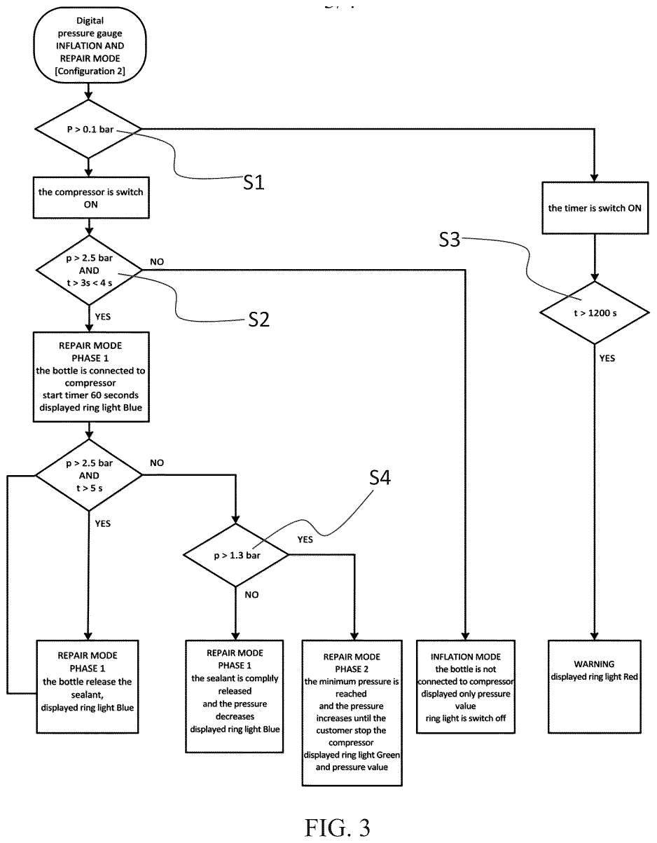

FIG. 4 shows a characteristic diagram of the relationship between pressure and compressor operating time.

### DETAILED DESCRIPTION OF THE INVENTION

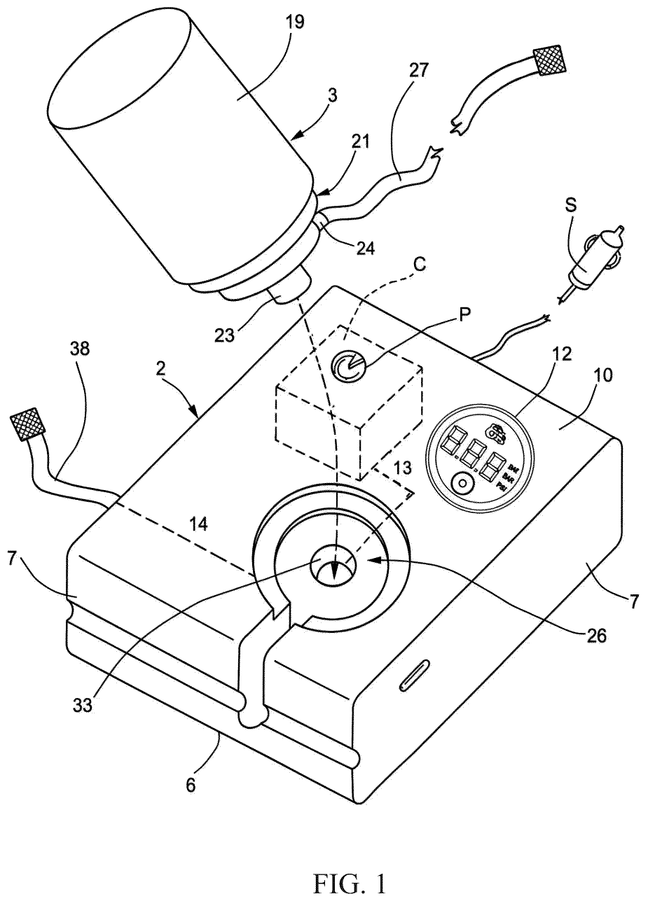

FIG. 1 shows a first embodiment of the portable handheld compressor, which can be sold as an accessory for vehicles, e. g., cars or vans, for inflating and repairing tires. Motorized land vehicle tires refers to those tires intended to be mounted, for example, on a car, motorcycle, van, electric motorized vehicle such as an e-bike, etc.

In FIG. 1, the compressor comprises a casing 2, a compressor unit C (schematically illustrated), which can be housed in an internal chamber of said casing 2, preferably consisting of an electric motor operable via a plug S, a connection device 26, and a display 12.

Preferably, the casing 2 is substantially parallelepipedal in shape and comprises a base wall 6, side walls 7 (of which only two are shown in FIG. 1), and an upper wall 10 that i substantially parallel to the base wall 6.

The compressor also includes a sealing liquid container 3 removably connected to the casing 2 and containing a known type of liquid sealant. The sealing liquid container 3 comprises a bottle 19 that defines a chamber containing the sealing liquid and a fluid unit 21, preferably screwed onto a threaded neck of the bottle 19. Specifically, the fluid unit 21 defines an inlet opening 23 that can be releasably connected to the compressor unit C and an outlet opening 24 that can be connected in use to a tire to be repaired via a flexible hose 27 connected to the outlet opening 24.

The sealing liquid container 3 also includes a valve (not shown) interposed between the inlet opening 23 and the outlet opening 24 and configured to open automatically when a pressurized airflow passes through the inlet opening 23.

The sealing liquid container 3 is releasably connected fluidically and mechanically to the casing 2 via the connection device 26, preferably a snap-on connection device, which is supported by the base wall 6.

The connection device 26 comprises a base rigidly connected to the casing 2 and a guide element superimposed on the base (not shown in the figure) and, in use, supporting the container group 3 and in particular the fluid unit 21 of the sealing liquid container 3, defining the inlet opening 23 and outlet opening 24.

The base defines a seat 33 that is open on the side opposite the base wall 6 along an axis perpendicular to the base wall 6, and a conduit, exemplified in the figure by a first dashed line 13, which fluidly connects the seat 33, sealed fluidly, to the compressor unit C.

The compressor also comprises a flexible hose 38 similar to hose 27 but connected to the compressor unit C in parallel with respect to the sealing liquid container 3 via a second conduit represented exemplarily in the figure by a second dashed line 14.

In the internal chamber located below the seat 33, there is a movable shutter element (not shown in the figure) configured to move from a first operating position to a second operating position to selectively direct the pressurized airflow from the compressor unit C.

When the compressor is in use and the sealing liquid container 3 is not mechanically and fluidly coupled to the compressor, the shutter element is in a first operating position that fluidly blocks the opening present on the base 33, directing the pressurized air from the compressor unit C to exit through the flexible hose 38.

Alternatively, when the sealing liquid container 3 is mechanically and fluidly coupled to the seat 33 during compressor operation, the shutter element (not shown in the figure) moves to the second operating position, which blocks the conduit represented by dashed line 14, directing the pressurized air from the compressor unit C towards the sealing liquid container 3 and out through the flexible hose 27.

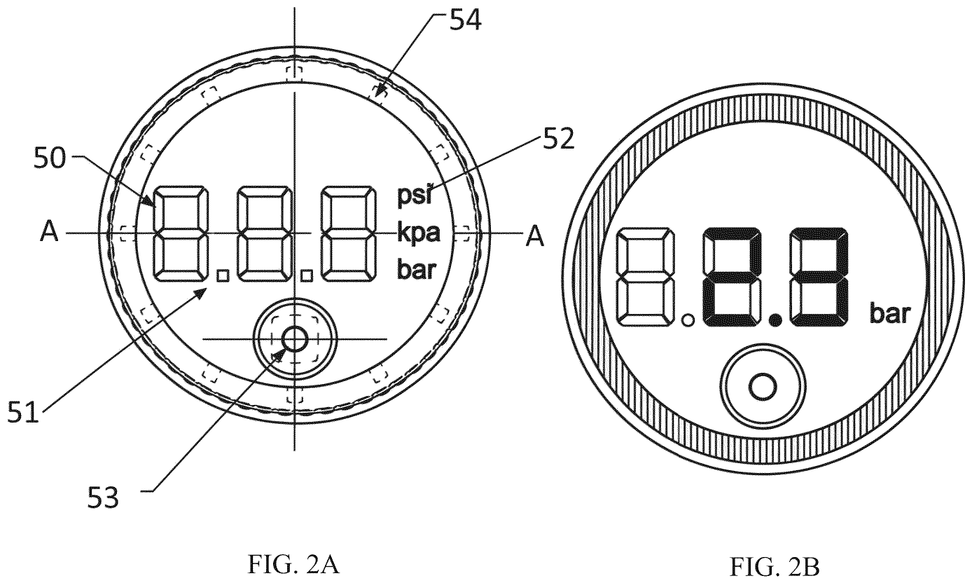

FIG. 2 shows the display 12 in detail, particularly FIG. 2a shows the elements present for displaying a measurement, while FIG. 2b shows an example in use of said display 12. Measurement refers to the information comprising a numerical value and a unit of measure to represent the value within a specific reference system.

According to a first preferred embodiment, the display 12, as shown in FIG. 2a, comprises at least one seven-segment LED 50 designed to digitally represent a numerical value between zero and nine as well as some alphabetical characters. According to a preferred embodiment, the at least one seven-segment LED 50 is symmetrically arranged on the display 12 with respect to a plane A-A. To represent numerical and alphabetical values, the LED segments are arranged in an “8” shape, with three LED segments arranged parallel to each other along a direction parallel to the A-A axis and spaced apart by a distance equal to the length of the segments themselves, four segments are arranged perpendicularly to the A-A plane so that the ends of each of said four segments are near a pair of ends belonging to two different segments arranged along the horizontal direction.

According to a preferred embodiment, the at least one seven-segment LED also includes a circular LED intended to represent a decimal point, positioned near the seven-segment LED.

The display 12 also includes a group of LEDs 52 representing the units of measurement in which the numerical value is expressed and a selection button 53 configured to convert the measurement according to different reference systems.

The use of LEDS within the display 12 allows for the visualization of pressure measurements even under extreme environmental conditions. Analog pressure gauges, for example, having mechanical components such as the needle and clockwork parts, can freeze and become stuck when exposed to temperatures below 0° C. Furthermore, condensation can form in extremely low temperatures, making it difficult to read the gauge. In contrast, the LEDs of the present invention are capable of operating within a wide temperature range from −40° C. to +85° C., and being luminous, they offer greater visibility to the user, both during the day and at night.

Lastly, the display 12 further includes a luminous device 54 configured to indicate an operational state during the inflation and/or repair operations of the compressor, as will be explained in more detail later. In particular, according to this embodiment, the luminous device 54 is made of circular LEDS arranged in a ring in the peripheral region of the display 12. However, it is possible that the luminous device 54, according to an unillustrated embodiment, is located on the casing 2 in a position distant from the display 12, without encircling the at least one seven-segment LED.

In the embodiment shown in FIG. 2, the different operational states can be indicated by illuminating different circular segments, illuminating the entire ring with different colours, making the entire ring or a segment of it blink differently, or a combination of the aforementioned methods.

The operational states of the compressor can be indicated in addition to or alternatively by acoustic devices so that the user does not need to look away to check the display.

Preferably, the seven-segment LED includes an additional circular LED segment 51, positioned to the right of the seven-segment LED 50, intended to represent a decimal point.

Preferably, the display 12 includes a plurality of seven-segment LEDs 50 and a plurality of circular LED segments 51 to represent numerical values with greater precision as well as some alphabetical codes indicating, for example, error codes.

Preferably, the display 12 comprises a plurality of nine, fourteen, and sixteen-segment LEDs capable of displaying all the letters of the alphabet to potentially generate complex text messages.

The display 12 also includes a layer of protective material to shield the LED components from various atmospheric agents, as well as dust and dirt.

The protective material can be made from different materials, such as glass or plexiglass.

This protective layer is designed to have a non-obscured area corresponding to the different underlying luminous parts, such as the LED segments, and an obscured area elsewhere such that when these segments are illuminated and emit light towards the protective layer, the display lights up in the non-obscured areas to show at least one alphanumeric character on the screen.

The preferred embodiment described above for the display 12 is one of the possible forms that the invention can take. Other forms may include a subset of the previously described components or their alternatives.

For example, in an alternative form of the display 12, the measurement is expressed in a single predefined unit. Therefore, in this embodiment, neither the selection button 53 nor the group of LEDs 52 are present, and the predefined unit of measure is printed or laser-etched directly onto the screen's glass.

Another alternative form of the display 12 includes a luminous device 54 made of multiple circular LEDs positioned at the top of the display 12, either above or below the seven-segment LEDs, arranged in a direction parallel to a horizontal symmetry axis A-A.

FIG. 2b shows an example of the display 12 in use, displaying a measurement that includes a numerical value and a unit of measure associated with that value. The display 12, as shown, highlights the activation of the luminous device 54, which in this specific example is realized as a circular ring in the peripheral region of the display 12.

The compressor includes a control device configured to drive the activation of the LEDs on the display 12 based on an input signal received from a pressure sensor representing a measured pressure value. The pressure sensor (not shown) is preferably located between the compressor group C outlet and the inlet 23 of the container 3. For example, the pressure sensor is on board the compressor 2. Said control device preferably uses a timer or other time-measuring device that activates when the compressor 2 itself is turned on to determine the operating period and a configuration that allows displaying pressure values on the display 12 and/or activating the luminous device 54 and/or the sound device corresponding to different operating modes during inflation and/or repair operations of a tire when predetermined threshold pressure values as a function of time are reached.

When a user uses the compressor 2, they connect the tire via a hose to establish a fluid connection for inflation and possibly also for injection. When the compressor is turned on, for example, via a button, if the pressure value measured by the pressure sensor exceeds a first predefined threshold, e.g., 0.1 bar, a timer is started, the operation of which will be better described later.

In the first scenario, by monitoring the pressure value over time, there is a gradual initial increase in the moments following the activation of the compressor group C and the airflow towards the tire. In this first operating state, the control device is programmed to recognize the inflation operation without prior injection of sealant liquid and is also programmed to show a first visual display where the detected pressure value is shown on the screen 12, as this value increases steadily. Additionally, the luminous device 54 remains off.

In the version that includes an acoustic device, this device is also turned off.

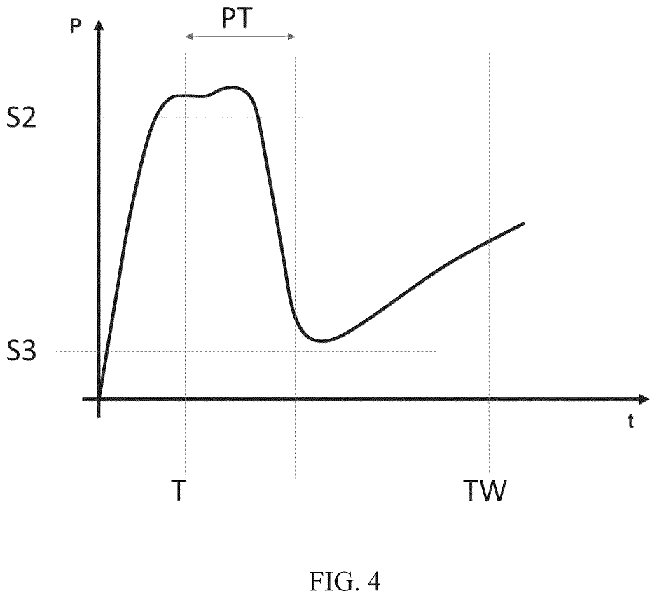

In a second scenario, immediately following the activation of the compressor group C, the pressure sensor instead detects an irregular pressure trend with high peaks (FIG. 4), e.g., equal to or greater than a second predefined threshold S2, such as equal to or greater than the maximum tire inflation pressure.

When a condition representing a second state of the compressor 2 occurs, i.e., the injection of sealant liquid, e.g., within a predetermined time interval T from the activation of the compressor group C, at least one of such pressure values above the second predefined threshold S2 is detected, the control device is programmed to execute a second visual display through the screen 12 and/or the luminous device 54. For example, the luminous device flashes, and, simultaneously, the screen 12 does not display any pressure value.

Exceeding the S2 threshold value represents the work done by the compressor group C to overcome the pressure losses of the fluid components and the viscosity of the sealant liquid contained inside the container 3, which is mechanically and fluidly connected to the compressor via the connecting device 26, so that the pressure generated by the flow of compressed air, passing through the container 3 and through the flexible tube 27, injects the sealant liquid into the inflatable object, preferably a tire.

When the second operating state is recognized, the control device counts a predetermined period of time PT. This predetermined period PT represents the time necessary to empty the sealant liquid container 3 into the inflatable object, during which the pressure is irregular. This period PT can, for example, be measured in the laboratory based on the model of the compressor 2 and the container 3. The second visual display is maintained for the predetermined period PT. In the version that includes an acoustic device, it will emit a first type of sound signal.

When the counter activated, e.g., at the moment the compressor's power button is pressed or upon exceeding the first pressure threshold, i.e., 0.1 bar, exceeds a predetermined compressor operating time value TW, which is longer than PT, the control device is programmed to recognize a third state of the compressor indicative of a malfunction. For example, the predetermined time TW is longer than the sum of the injection and inflation phases and, preferably but not exclusively, represents the maximum continuous operation time of the compressor.

In this third state of the compressor, the control device is programmed to correspond a third display of the screen 12 and/or the device 54 different from the first and the second, e.g., the screen 12 does not display any pressure value, and the luminous device 54 turns on, illuminating the circular LEDs arranged in a ring in the peripheral region of the screen 12, or a segment of it, with a third fixed or flashing color different from the first and the second. In the version that also includes an acoustic device, it will emit a third type of sound signal.

After the control device has calculated an elapsed time equal to the predetermined period PT in the second operating state, a second pressure value P2 is periodically detected.

When the detected value is higher than a third predetermined threshold S3, the compressor is configured to switch to a fourth operating state, i.e., post-sealant injection inflation, and a corresponding fourth visual display.

Since the pressure is more regular, the fourth visual display involves the screen 12 showing the pressure measurement within the inflatable object, preferably a tire. Additionally, the luminous device 54 lights up, illuminating the circular LEDs arranged in a ring in the peripheral region of the screen 12, or a segment of it, with a second fixed or flashing color different from the first, second, and third. In the version that includes an acoustic device, it will emit a second type of sound signal. FIG. 4 shows a characteristic diagram of the pressure values detected by a pressure sensor in the compressor.

The peak with a value equal to or greater than the S2 threshold does not correspond to the actual tire pressure but to the sealant injection phase. The S3 threshold value approximately corresponds to when the container 3 is empty, and after this threshold, the pressure value can be displayed on the screen 12. Lastly, the time TW is related to the compressor's usage and serves to identify potential operational issues. Indeed, this predetermined value is set to a magnitude greater than the normal time required to complete the tire inflation and/or repair operation.

According to a non-limiting embodiment, the control unit is programmed to automatically stop the compressor P when a pre-set threshold pressure is reached, e.g., pre-set by a user. This prevents the user, possibly distracted, from manually stopping the compressor P at an unsuitable pressure, whether higher or lower than the optimal pressure.

According to a non-limiting embodiment, the compressor P is fluidly and mechanically connected to the sealant liquid container even when stored at rest on board the vehicle as a spare tire replacement device. In such embodiment, a preferably manual selector valve is movable between a position where the compressor P's flow is sent into the sealant liquid container to achieve the sealant injection function into the inflatable object, e.g., a tire, and another position where the compressor's flow is sent directly to the inflatable object, e. g., a tire, bypassing the sealant liquid container mechanically connected to the compressor P to achieve inflation only.

1. A method for controlling the operating state of a compressor comprising a light (54) and/or sound device to signal a user about the operating state of an inflating device, a compressor unit (C), and a releasable connection to fluidly connect a sealant liquid container to the compressor, said inflating device can be configured in a first operating state for inflation only and in a second operating state for injecting the sealant liquid via the compressor's action to repair an inflatable object comprising the steps of:
detecting a pressure value P between the compressor and the releasable connection via a pressure sensor after a predefined and non-zero time interval (T) from the compressor's activation, with the interval defined by a counter;
when the pressure value does not exceed a first predetermined threshold (S2) within a predetermined time (T) defined by the counter, configuring the light (54) and/or sound device in a first signalling configuration; or
when the pressure value exceeds the first predetermined threshold (S2) within the said predetermined time (T), turning on the light (54) and/or sound device in a second signalling configuration different from the first signalling configuration to inform the user of the ongoing sealant liquid injection.

2. The control method according to the previous claim, in which the second signalling configuration further comprises the steps of:
calculating a time period equal to a predetermined period (PT) starting from the activation of the light (54) and/or sound device in the second signalling configuration;
detecting a second pressure value P2 at the end of the predetermined period (PT);

3. when the pressure value exceeds a second threshold (S3), turning on the light (54) and/or sound device in a fourth signalling configuration different from the first and second signalling configurations to inform the user that the compressor is in a post-sealant injection inflation mode.

4. A compressor for inflating tires of a motorized land vehicle comprising a light (54) and/or sound device to signal a user about the operating state of an inflating device, a compressor unit (C), and a releasable connection to fluidly connect a sealant liquid container to the compressor said inflating device can be configured in a first operating state for inflation only and in a second operating state for injecting the sealant liquid via the compressor's action to repair an inflatable object, the compressor further comprises an electronic control unit programmed to:
detect a pressure value P between the compressor and the releasable connection via a pressure sensor after a predefined and non-zero time interval (T) from the compressor's activation, with the interval defined by a counter;
when the pressure value does not exceed a first predetermined threshold (S2) within a predetermined time (T) defined by the counter, configure the light (54) and/or sound device in a first signalling configuration; or
when the pressure value exceeds the first predetermined threshold (S2) within the said predetermined time (T), turn on the light (54) and/or sound device in a second signalling configuration different from the first signalling configuration to inform the user of the ongoing sealant liquid injection.

5. The compressor according to claim 4, configured to be handheld, comprising:
an outer casing (2);
a compressor unit (C), preferably with an electric motor, enclosed within the casing (2);
a screen (12) applied to the casing comprising:
at least one seven-segment LED (50) to represent a number or letter, one LED being provided for each of the segments;
a layer positioned above the at least one seven-segment LED having a non-obscured area corresponding to the underlying LED segments and an obscured area elsewhere so that when said segments are illuminated and emit light toward the protective material layer, the screen is illuminated in the non-obscured areas to display at least one alphanumeric character on the screen;
a pressure sensor connected to an inflation line attached to the outlet of the compressor unit;
a control device for the LEDs to manage the illumination of the LED segments based on the temporal trend of a signal received from the pressure sensor.

6. The compressor according to claim 5, in which the screen (12) further comprising at least one circular LED segment (51) next to the at least one seven-segment LED (50) to represent a decimal point.

7. The compressor according to claim 5 or 6, in which said screen (12) further comprising a group of LEDs (52) representing the possible units of pressure measurement in which the numerical value is expressed and a selection button (53) configured to convert the measurement according to multiple reference systems.

8. The compressor according to the previous claims, further comprising an acoustic device, in which the said control device is programmed to signal to a user via the acoustic device, when the compressor is in use, the first or second operating state during inflation and/or repair operations.

9. The compressor according to any of claims 5 to 8, in which the screen (12) comprising nine, fourteen, or sixteen-segment LEDS capable of q displaying all alphanumeric characters to generate complex text messages in addition or as an alternative to acoustic and/or visual signals.
